(19) United States
(12) Patent Application Publication
(10) Pub. No.: US 2025/0148727 A1
(43) Pub. Date: May 8, 2025

(54) INFORMATION PROCESSING APPARATUS CONTROLLING REPRODUCTION OF VIDEO OF VIRTUAL OBJECT, CONTROL METHOD OF INFORMATION PROCESSING APPARATUS, AND STORAGE MEDIUM

(71) Applicant: CANON KABUSHIKI KAISHA, Tokyo (JP)

(72) Inventor: TOSHIYUKI TAKAGI, Kanagawa (JP)

(21) Appl. No.: 18/939,371

(22) Filed: Nov. 6, 2024

(30) Foreign Application Priority Data
Nov. 8, 2023 (JP) 2023-191179

(51) Int. Cl. G06T 19/00; G06T 7/73; G09B 5/02

(52) U.S. Cl. CPC G06T 19/006; G06T 7/73; G09B 5/02; G06T 2207/10016; G06T 2207/30204

(57) ABSTRACT

An information processing apparatus connected to or integrated into a head-mounted display apparatus includes a processor, and a memory storing a program which, when executed by the processor, causes the information processing apparatus to execute first acquisition processing of acquiring first information regarding a position or an orientation of a virtual object corresponding to an instructor from a recording unit, execute second acquisition processing of acquiring second information regarding a position or an orientation of an operation apparatus supported by a learner, and execute control processing of controlling reproduction of a video of the virtual object corresponding to the instructor, based on a difference between the first information acquired by the first acquisition processing and the second information acquired by the second acquisition processing.

### BACKGROUND

### Field of the Disclosure

The present disclosure relates to an information processing apparatus.

### Description of the Related Art

In the system of cross reality (XR) that causes a user to experience virtual reality, a head-mounted display (HMD) has been conventionally a head-mounted display device including a compact display to be mounted on the head of the user. The HMD has been utilized to learn a working process or sport. At this time, the HMD displays an instructor who gives an instruction when the user learns the working process or the sport, as a virtual object, and a wearer of the HMD can view the virtual object together with an operation of himself/herself.

Japanese Patent Application Laid-Open No. 2020-144233 discusses a method of controlling a reproduction speed of a model moving image in such a manner that the speed of a working operation of an instructor that is included in the model moving image is adapted to the speed of a working operation of a learner, based on the working operation of the learner that is included in a viewing field video captured by an imaging unit.

Because the above-described prior art discussed in Japanese Patent Application Laid-Open No. 2020-144233 is based on the working operation of the learner that is included in the viewing field video captured by the imaging unit, depending on the position and the orientation of a region of the body of the learner, the working operation of the learner is sometimes hidden and fails to be recognized.

### SUMMARY

In view of the foregoing, the present disclosure is directed to reducing a failure in recognition of the working operation of the learner that is caused depending on the position and the orientation of a region of the body of the learner. According to an aspect of the present disclosure, an information processing apparatus connected to or integrated into a head-mounted display apparatus includes a processor, and a memory storing a program which, when executed by the processor, causes the information processing apparatus to execute first acquisition processing of acquiring first information regarding a position or an orientation of a virtual object corresponding to an instructor from a recording unit, execute second acquisition processing of acquiring second information regarding a position or an orientation of an operation apparatus supported by a learner, and execute control processing of controlling reproduction of a video of the virtual object corresponding to the instructor, based on a difference between the first information acquired by the first acquisition processing and the second information acquired by the second acquisition processing.

Further features of the present disclosure will become apparent from the following description of exemplary embodiments with reference to the attached drawings.

### BRIEF DESCRIPTION OF THE DRAWINGS

FIG. 1A is a diagram illustrating an information processing system according to one or more aspects of the present disclosure.

FIG. 1B is a block diagram illustrating the first exemplary embodiment.

FIG. 2A is a diagram illustrating an example in which an instructor is displayed as a virtual object according one or more aspects of the present disclosure.

FIG. 2B is a diagram illustrating an example of translucently displaying a virtual object when a wearer is moving according to one or more aspects of the present disclosure.

FIG. 3A illustrates a table indicating movement information of a virtual object according to one or more aspects of the present disclosure.

FIG. 3B illustrates a table indicating movement information of a wearer according to one or more aspects of the present disclosure.

FIG. 4 is a flowchart according to the first exemplary embodiment that illustrates processing of determining whether a wearer is moving.

FIG. 5A is a diagram illustrating an example of displaying a virtual object being superimposed on a hand of a wearer according to one or more aspects of the present disclosure.

FIG. 5B is a diagram illustrating an example of displaying a virtual object in such a manner that a hand of a wearer on the virtual object is displayed according to one or more aspects of the present disclosure.

FIG. 6 is a schematic diagram illustrating a case of capturing an image of a wearer of a head-mounted display (HMD) using an external camera according to one or more aspects of the present disclosure.

FIG. 7A is a diagram illustrating an example of an image to be displayed when a difference exists within a viewing field of a wearer according to one or more aspects of the present disclosure.

FIG. 7B is a diagram illustrating an example of an image to be displayed when a difference exists outside a viewing field of a wearer according to one or more aspects of the present disclosure.

FIG. 8 is a flowchart illustrating processing of comparing movement information of a virtual object and movement information of a wearer according to one or more aspects of the present disclosure.

FIG. 9A is a diagram illustrating an example of starting moving image reproduction of a virtual object according to one or more aspects of the present disclosure.

FIG. 9B is a diagram illustrating an example of stopping moving image reproduction of a virtual object according to one or more aspects of the present disclosure.

FIG. 9C is a diagram illustrating an example of restarting moving image reproduction of a virtual object according to one or more aspects of the present disclosure.

FIG. 10 is a flowchart illustrating processing of performing reproduction stop of a virtual object according to one or more aspects of the present disclosure.

FIG. 11 is a flowchart illustrating processing of determining whether to make a display change at the time of second-time learning or later according to one or more aspects of the present disclosure.

FIG. 12A is a diagram illustrating a movement locus of a virtual object and a movement locus of a wearer in a predetermined section, and a difference therebetween, in a case where the difference is smaller than a threshold value according to one or more aspects of the present disclosure.

FIG. 12B is a diagram illustrating a movement locus of a virtual object and a movement locus of a wearer in a predetermined section, and a difference therebetween, in a case where the difference is larger than a threshold value according to one or more aspects of the present disclosure.

FIG. 13 is a flowchart illustrating processing of determining whether to reproduce the next series of movements or reproduce the same series of movements again after a series of movements is reproduced according to one or more aspects of the present disclosure.

### DESCRIPTION OF THE EMBODIMENTS

Hereinafter, exemplary embodiments of the present disclosure will be described in detail based on the accompanying drawings. The exemplary embodiments to be described below serve as an example of an implementation tool of the present disclosure, and may be appropriately modified or changed depending on the configuration of an apparatus to which the present disclosure is applied, and various conditions. The exemplary embodiments can also be appropriately combined.

### <System Configuration>

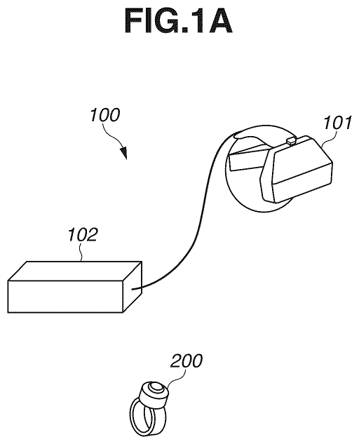

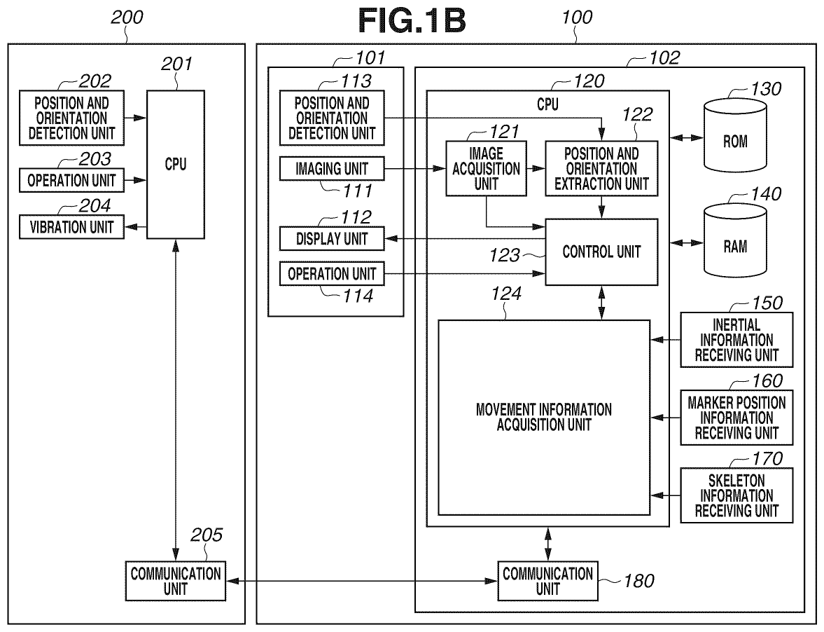

An information processing system according to a first exemplary embodiment will be described with reference to FIG. 1A. The information processing system includes a head-mounted display (HMD) 100 including a display apparatus 101 and a control apparatus 102, and a controller 200. The controller 200 is an apparatus for performing various operations of the HMD 100.

An internal configuration of the HMD 100, which is an example of an information processing apparatus, and an internal configuration of the controller 200 will be described with reference to FIG. 1B.

### <Configuration of Display Apparatus 101>

The display apparatus 101 includes an imaging unit 111, a display unit 112, a position and orientation detection unit 113, and an operation unit 114.

For example, the display apparatus 101 is formed as a glasses-type display portion of the HMD 100 and detects the position and the orientation of a user wearing the display apparatus 101. Then, the display apparatus 101 displays a combined image obtained by combining a captured image of a front-side range of the user and a virtual object indicated by a computer graphics (CG) in a form suitable for the detected position and orientation.

The user wearing the display apparatus 101 can thereby observe a virtual reality image in which a CG is displayed in a superimposed manner in a virtual space adapted to a line-of-sight-direction in a real space. To generate a stereo image, two display units corresponding to a display unit for a right eye and a display unit for a left eye may be implemented. In the following description, the display apparatus 101 is assumed to be a glasses-type display portion of the HMD 100, but may be a display apparatus such as a tablet terminal or a smartphone. That is, an arbitrary display apparatus that is portable and can display an image corresponding to a viewing field of the user can be used.

The imaging unit 111 includes an objective optical system that takes in a real video of an external world as light, and an image sensor that converts an optical signal into an electric signal. The imaging unit 111 includes two cameras (imaging apparatuses). The two cameras capture captured images to be used in the combining with an image of a virtual space and the generation of position and orientation information, and include an imaging unit for a left eye and an imaging unit for a right eye. The imaging unit for the left eye captures a moving image of the real space that corresponds to the left eye of the wearer of the display apparatus 101, and an image of each frame (captured image) in the moving image is output from the imaging unit for the left eye. The imaging unit for the right eye captures a moving image of the real space that corresponds to the right eye of the wearer of the display apparatus 101, and an image of each frame (captured image) in the moving image is output from the imaging unit for the right eye. That is, the imaging unit 111 acquires a captured image that is a stereo image having a parallax approximately corresponding to the positions of the left eye and the right eye of the wearer of the display apparatus 101. By distance measurement executed by the stereo camera, information regarding distances from the two cameras to a subject can be acquired as distance information. In an HMD for a mixed reality (MR) system, a central optical axis of an image capturing range of an imaging unit is desirably arranged in such a manner as to approximately correspond to a line-of-sight-direction of a wearer of the HMD. Alternatively, a method of arranging an imaging unit at a position where a central optical axis of an image capturing range of the imaging unit does not correspond to a line-of-sight-direction of a wearer of an HMD, and converting a position of a viewpoint in such a manner as to correspond to the line-of-sight-direction of the wearer of the HMD (view conversion method) may be employed.

The imaging unit for the left eye and the imaging unit for the right eye each include an optical system and an imaging device. Light that has entered from the external world enters the imaging device via the optical system, and the imaging device outputs an image corresponding to the incident light, as a captured image. Images of a subject (front-side range of the user) captured by two cameras are output to the control apparatus 102. The imaging unit 111 may capture a video and output the video in place of captured images.

The display unit 112 displays an image generated by the control apparatus 102. The display unit 112 includes a liquid crystal panel or an organic electroluminescence (EL) panel. In a state in which the user wears the display apparatus 101, the display unit 112 is arranged in front of each eye of the user. A device that uses a semi-transmissive half mirror can also be used as the display unit 112. In this case, for example, by a technique such as a technique generally called augmented reality (AR), the display unit 112 may display an image in such a manner that a CG appears as if the CG was directly superimposed on a real space visible through the half mirror. Alternatively, by a technique such as a technique generally called virtual reality (VR), the display unit 112 may display an image of a complete virtual space without using a captured image.

The position and orientation detection unit 113 is a functional unit for acquiring the position and the orientation of the display apparatus 101, and can calculate an orientation change, a relative direction, and a position in the real space of the display apparatus 101. For example, an inertial measurement unit (IMU; inertial sensor) that can detect inertial information (spatial movement amount and angle), a direction sensor that uses geomagnetism, and an orientation detection sensor that uses a global positioning system (GPS) can be used.

The position and orientation detection unit 113 is assumed to be a functional unit that acquires at least either of the position or the orientation of the display apparatus 101.

The operation unit 114 is a device for the user to operate the HMD 100. For example, the operation unit 114 may be an operation member such as a button, or a mouse or a keyboard may be used. By operating the operation unit 114, the user performs the switching between display and non-display of the display unit 112, and the setting of a pupillary distance to be described below.

### <Configuration of Control Apparatus 102>

The control apparatus 102 includes a central processing unit (CPU) 120, a read-only memory (ROM) 130, a random access memory (RAM) 140, an inertial information receiving unit 150, a marker position information receiving unit 160, a skeleton information receiving unit 170, and a communication unit 180. An image acquisition unit 121, a position and orientation extraction unit 122, a control unit 123, and a movement information acquisition unit 124 are control blocks operating in the CPU 120.

Here, an apparatus having a high-performance arithmetic processing function and a graphic display function, such as a smartphone, a personal computer (PC), and a workstation is assumed to be used as the control apparatus 102.

By connecting the control apparatus 102 and the display apparatus 101, the user wearing the display apparatus 101 becomes able to view a VR video, which is a video of a virtual space. Instead of the video of the virtual space, the user may view a mixed reality (MR) video, which is a video of a mixed real world in which the real world and the virtual world are seamlessly fused in real time.

The image acquisition unit 121 acquires an image of the real space (reality image) that has been acquired by the imaging unit 111.

The position and orientation extraction unit 122 acquires position and orientation information detected by the position and orientation detection unit 113. Furthermore, the position and orientation extraction unit 122 may be configured to detect a marker arranged in the real space, from the reality image acquired by the image acquisition unit 121, and calculate a position and an orientation.

The control unit 123 generates an image in which the reality image acquired by the image acquisition unit 121 and a CG are combined, and transmits a combined image to the display unit 112. For this reason, by wearing the display apparatus 101, the user can view a combined image displayed on the display unit 112. The user can experience various mixed realities in which a CG appears as if the CG was fused with the real space. Instead of the control unit 123 controlling the entire apparatus, a plurality of hardware components may control the entire apparatus while sharing processing.

Based on information (distance information and orientation information) acquired by the display apparatus 101, the control unit 123 controls the position, the orientation, and the size of a CG in a combined image. For example, in the case of arranging a virtual object indicated by a CG, in a space indicated by a combined image, near a specific object existing in the real space, the control unit 123 increases the size of the virtual object (CG) as a distance between the specific object and the imaging unit 111 gets smaller. By controlling the position, the orientation, and the size of the CG in this manner, the control unit 123 can generate a combined image as if a CG object not arranged in the real space was arranged in the real space.

In the control unit 123, the communication unit 180 receives change information of the position or the orientation of the controller 200 from a communication unit 205 of the controller 200. The control unit 123 displays an instruction position corresponding to the change information of the position or the orientation of the controller 200 in a superimposed manner on the combined image. The control unit 123 may display an instruction position corresponding to the change information of the position and the orientation of the controller 200 in a superimposed manner on the combined image.

The movement information acquisition unit 124 acquires movement information regarding the movement of limbs and fingers of the wearer of the HMD 100 from information received from at least any of the inertial information receiving unit 150, the marker position information receiving unit 160, and the skeleton information receiving unit 170, which will be described below.

The ROM 130 is an electrically erasable and recordable nonvolatile memory that stores information regarding a CG or the like. From movement information and human body shape information of limbs and fingers of an instructor that are stored in the ROM 130, the control unit 123 generates limbs and fingers of the instructor as a CG serving as a virtual object, reproduces the generated virtual object as a moving image in accordance with the movement information, and displays the moving image on the display unit 112. The stored movement information of limbs and fingers of the instructor may be movement information of somebody else who serves as a teacher when the user learns sport or a working process in facilities such as a factory, or may be movement information obtained when the user oneself has done the operations in the past. The control unit 123 can switch a CG to be read out from the ROM 130 (i.e., CG to be used in the generation of a combined image). To display limbs and fingers of an instructor as a virtual object, the movement of the body of the instructor may be acquired in advance. In this case, the movement of the body may be acquired from a captured image or a video, or may be acquired using a movement information acquisition method that uses a marker described below, or a tracking device. Movement information of a learner may be acquired using a method different from a method used when the movement of the instructor is acquired.

The RAM 140 is used as a buffer memory for temporarily holding image data of images captured by the imaging unit 111, a memory for image display of the display unit 112, and a work area of the control unit 123. The RAM 140 also temporarily holds data of the position, the orientation, and the movement locus of a region of the body of a learner.

The inertial information receiving unit 150 receives inertial information from a tracking device attached to a limb or a finger of the wearer. The movement information acquisition unit 124 calculates movement information regarding the movement of the limb or the finger of the wearer from the inertial information received from the inertial information receiving unit 150.

The marker position information receiving unit 160 receives marker position information from an apparatus that captures an image of a marker of the limb or the finger of the wearer using an external camera and performs the measurement of the position the marker. The movement information acquisition unit 124 calculates movement information regarding the movement of the limb or the finger of the wearer from the marker position information received from the marker position information receiving unit 160.

The skeleton information receiving unit 170 is a unit that receives skeleton information from an apparatus that captures an image of a wearer using an external camera and generates skeleton information of the wearer from the captured image. The movement information acquisition unit 124 calculates movement information regarding the movement of the limb or the finger of the wearer from the skeleton information received from the skeleton information receiving unit 170.

The control unit 123 performs the control of the HMD 100 based on a value acquired via the communication unit 180 and input from the controller 200.

The communication unit 180 is an interface for communicating with an external apparatus via a wireless local area network (LAN) complying with the standard of IEEE802.11, or Bluetooth (registered trademark). Nevertheless, a communication method is not limited to the wireless LAN and the Bluetooth, and any communication protocol may be used irrespective of whether communication is performed wirelessly or via a cable, as long as communication can be executed.

The HMD 100 performs communication with the controller 200 via the communication unit 180. The communication unit 180 can also perform communication with a device other than the controller 200, such as a smartphone or a tablet terminal, for example.

The display apparatus 101 and the control apparatus 102 are connected in such a manner that data communication can be performed therebetween.

Accordingly, the display apparatus 101 and the control apparatus 102 may be connected via a cable or wirelessly. The display apparatus 101 and the control apparatus 102 may be integrally formed in such a manner as to be portable by the user. For example, the HMD 100 may be a stand-alone HMD.

From an image captured by the display apparatus 101, the position and the orientation of the display apparatus 101 may be estimated. As a self-location estimation method that uses a captured image, simultaneous localization and mapping (SLAM) has been known. The SLAM is disclosed as a method of detecting the position of a feature point in a camera video, and obtaining a self-location on a three-dimensional space from a movement amount of the feature point position between frames. It has been known to estimate a self-location on the three-dimensional space from these feature points using various disclosed algorithms of the SLAM.

### <Configuration of Controller 200>

An internal configuration of the controller 200 will be described with reference to FIG. 1B. The controller 200 includes a CPU 201, a position and orientation detection unit 202, an operation unit 203, a vibration unit 204, and a communication unit 205.

The CPU 201 is a control unit that controls each component of the controller 200. Instead of the CPU 201 controlling the entire apparatus, a plurality of hardware components may control the entire apparatus while sharing processing.

The position and orientation detection unit 202 is a functional unit for acquiring the position and the orientation of the controller 200, and can calculate an orientation change, a relative direction, and a position in the real space of the controller 200. For example, an IMU (inertial sensor) that can detect inertial information (spatial movement amount and angle), a direction sensor that uses geomagnetism, and an orientation detection sensor that uses the GPS can be used. Any device may be used as the position and orientation detection unit 202 as long as that device does not disturb downsizing of the controller 200, and can detect inertial information (information such as position variation, speed, or acceleration).

The position and orientation detection unit 202 is assumed to be a functional unit that acquires at least either of the position or the orientation of the controller 200.

The operation unit 203 may include any of a button, a touchpad, a touch panel, an arrow key, a joystick, and a trackpad device. The user displays a menu including a pointer on the HMD 100 by the long press of a button, for example. Then, by pressing in the arrow key in an arbitrary direction, the user can place the pointer on a desired item. Then, the user can perform a determination operation of determining the selection of the item by pressing in the button. For example, it becomes possible to switch the display and non-display of a ray, by displaying the ray in the menu and selecting the ray. Operation information in the operation unit 203 is transmitted to the HMD 100 via the communication unit 205.

The vibration unit 204 vibrates the controller 200. For example, when the ray touches a CG, the CPU 201 may control the vibration unit 204 and vibrate the controller 200 upon receiving a vibration instruction from the HMD 100 via the communication unit 205. By the controller 200 vibrating, the user can notice that the ray has come into contact with the CG.

The communication unit 205 performs wireless communication with the communication unit 105 of the HMD 100. In a case where there is a plurality of controllers, each controller performs wireless communication with the communication unit 105.

The controller 200 may include an output unit. The output unit includes a light source such as a light-emitting diode (LED) and a speaker.

The controller 200 may include a camera for estimating the self-location of the controller 200. The self-location of the controller 200 on the three-dimensional space may be estimated using the above-described various disclosed algorithms of the SLAM.

### <Display: Translucently Display Virtual Object When Wearer Is Moving>

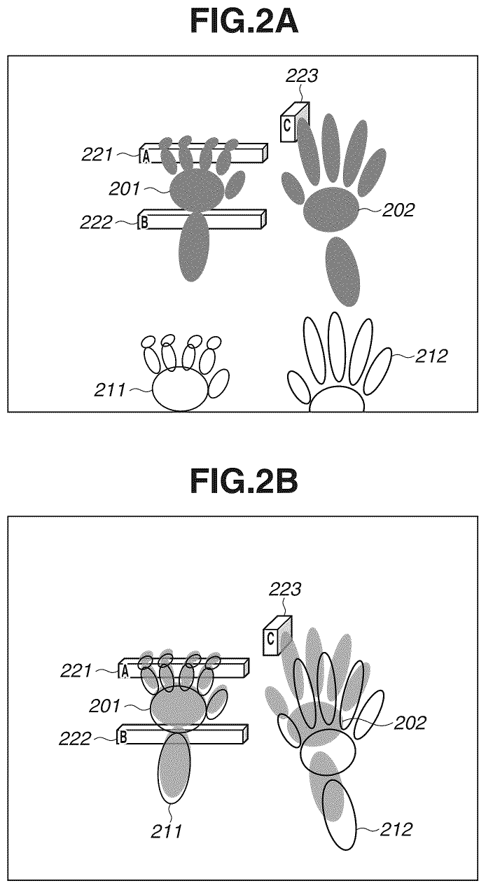

FIG. 2A is a diagram illustrating an example in which an instructor is displayed as a virtual object. A virtual object 231 is a left hand of the instructor, and a virtual object 232 is a right hand of the instructor. A left hand 211 and a right hand 212 are the left hand and the right hand of the wearer of the HMD 100 that have been image-captured by the imaging unit 111. A member A (221), a member B (222), and a member C (223) are real members that have also been image-captured by the imaging unit 111. The control unit 123 acquires the images of the left hand 211, the right hand 212, the member A (221), the member B (222), and the member C (223) from the image acquisition unit 121, and checks the positions of the member A (221), the member B (222), and the member C (223). Then, the control unit 123 displays the virtual objects 231 and 232 at positions where the virtual objects 231 and 232 appear to operate these members, generates a combined image of the real members and the virtual objects, and displays the combined image on the display unit 112. The control unit 123 also reproduces the virtual objects 231 and 232 as a moving image in accordance with movement information stored in the ROM 130.

FIG. 2B is a diagram illustrating an example of translucently displaying a virtual object when a wearer is moving.

The control unit 123 determines whether a wearer is moving, based on the movement information of the wearer that has been acquired from the movement information acquisition unit 124, and in a case where the wearer is operating, displays the virtual objects 231 and 232 translucently or in another color such as gray. In this example, the virtual object 231 (left hand) grasps the member A (221) and the virtual object 232 (right hand) presses in the member C (223). If the virtual objects 231 and 232 become translucent, the members become more visually recognizable to the wearer, and the wearer becomes able to move in accordance with the movement of the virtual objects 231 and 232.

Alternatively, control may be performed in such a manner that the virtual objects 231 and 232 always become translucent not only in a case where the wearer is moving.

### <Acquisition of Movement Information by Tracking Device>

The inertial information receiving unit 150 receives inertial information from a tracking device supported by a wearer, which is a learner, with use of a limb or fingers. The tracking device may have a graspable shape or a shape attachable to a limb or a finger. The tracking device may be the controller 200 illustrated in FIGS. 1A and 1B, or may be a glove-shaped device. The tracking device is not limited to a device that tracks a limb or a finger, and the tracking device may be attached to a tool in such a manner as to track the tool, or a tool incorporating the tracking device may be used. The movement information acquisition unit 124 calculates movement information regarding the movement of a limb or a finger of the wearer from the inertial information received from the inertial information receiving unit 150. While the movement amount of the position of the tracking device may be directly detectable, only the speed of the movement or the acceleration of the movement of the tracking device may be directly detectable. In a case where the speed of the movement has been acquired, a movement amount can be calculated by integrating the speed. Alternatively, in a case where the acceleration of the movement has been acquired, a movement amount can be calculated by integrating the acceleration twice.

Not only the movement amount of the position but also the movement amount of an orientation or a slope may be acquired. The movement amount of the orientation or the slope may be calculated by integrating an angular speed or integrating an angular acceleration twice.

Information regarding one of a change in position or a change in orientation may be regarded as movement information, or information regarding changes in both of the position and the orientation may be regarded as movement information.

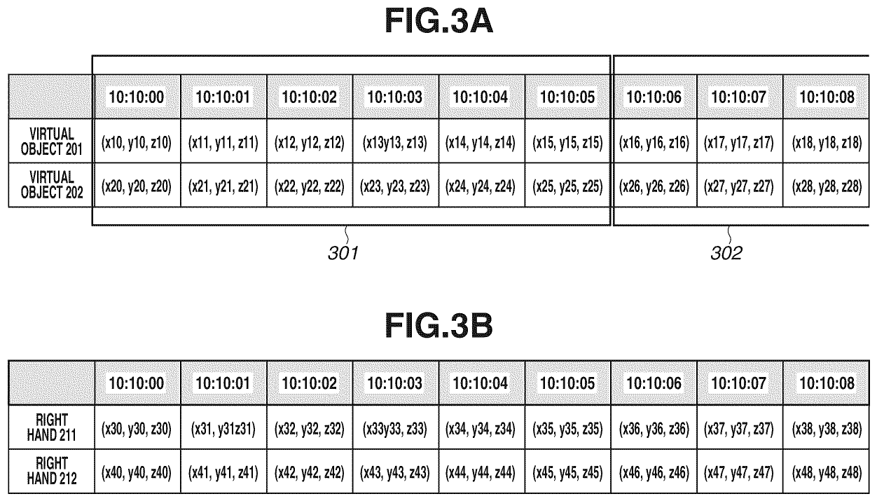

FIG. 3A illustrates a table indicating movement information of a virtual object, and indicating amounts by which the virtual objects 231 and 232 move in x, y, and z directions per second. The first line indicates a time, and pieces of movement information from 10:10:01 to 10:10:08 is indicated. The information is stored in the RAM 140. Sections 301 and 302 indicating sections will be described below.

FIG. 3B illustrates a table indicating movement information of a wearer, and indicating amounts by which the left hand 211 and the right hand 212 of the wearer move in the x, y, and z directions per second. The first line indicates a time, and pieces of movement information from 10:10:01 to 10:10:08 is indicated. The control unit 123 acquires these pieces of movement information by the movement information acquisition unit 124.

The control unit 123 determines whether a wearer is making the same movement as a virtual object, based on whether movement amounts in FIGS. 3A and 3B are the same. Even when the time of the operation of the wearer differs from the time of the operation of the virtual object, as long as their movement loci are the same, it may be determined that the wearer and the virtual object are making the same movement.

### <Processing of Determining Whether Wearer Is Moving>

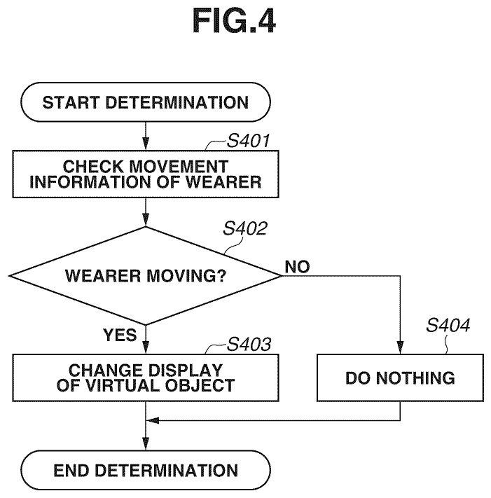

FIG. 4 is a flowchart illustrating processing of determining whether a wearer is moving.

In step S401, the control unit 123 acquires movement information of a wearer from the movement information acquisition unit 124, and the processing proceeds to step S402.

In step S402, the control unit 123 determines whether the wearer is moving, based on the acquired movement information. The control unit 123 checks whether a movement amount per second is smaller than a predetermined threshold value, and in a case where a time during which the movement amount per second is smaller than the predetermined threshold value continues for a certain period of time, the control unit 123 determines that the wearer is not moving. In this example, the determination is made based on whether a movement amount per second is smaller than a threshold value, but the number of seconds is not limited to one second, and a movement amount per several seconds may be acquired. In a case where the control unit 123 determines that the wearer is moving (YES in step S402), the processing proceeds to step S403. In a case where the control unit 123 determines that the wearer is not moving (NO in step S402), the processing proceeds to step S404.

In step S403, the control unit 123 changes the display of a virtual object, displays the virtual object translucently or in another color such as gray, and completes the processing.

In step S404, the control unit 123 completes the processing without doing anything.

In this manner, in a case where a wearer is moving, the members become more visually recognizable to the wearer by the virtual objects 231 and 232 becoming translucent, and the wearer becomes able to move in accordance with the movement of the virtual objects 231 and 232.

<Acquisition of Movement Information that Uses Marker>

Position information of the limb or the finger of the wearer may be acquired by adding a marker to a limb or a finger of the wearer. At this time, the marker position information receiving unit 160 receives marker position information from an apparatus that captures an image of a marker on the limb or the finger of the wearer and performs the measurement of the position the marker. The movement information acquisition unit 124 calculates movement information regarding the movement of the limb or the finger of the wearer based on the marker position information received from the marker position information receiving unit 160.

A camera that captures an image of the marker may be immovably installed at a predetermined position in the real space as an external apparatus, or the position of the marker measured by an external apparatus may be received by the marker position information receiving unit 160. Alternatively, a camera that captures an image of the marker may be the imaging unit 111 of the display apparatus 101, or position information of the marker that is received by the marker position information receiving unit 160 may be measured by the control unit 123. The number of cameras that capture the image of the marker is not limited to one. A plurality of cameras may capture images of the marker, and the position of the marker may be measured from the captured images and videos of the cameras. The marker may also be attached to a device or a tool to be grasped by or worn by the wearer in addition to being attached to the wearer.

### <Acquisition of Movement Information That Is Based in Image>

A camera may capture an image of a wearer, and position information of the limb or the finger of the wearer may be acquired from image information regarding the captured image. At this time, the skeleton information receiving unit 170 receives skeleton information from an apparatus that captures an image of a wearer using an external camera and generates skeleton information of the wearer from the captured image. The movement information acquisition unit 124 calculates movement information regarding the movement of the limb or the finger of the wearer based on the skeleton information received from the skeleton information receiving unit 170.

The description has been given of an example in which inertial information, marker position information, and skeleton information are received to calculate movement information of the limb or the finger of the wearer. The movement information indicates a movement amount of a hand, a finger, a foot, a joint point, or a bone angle, from a certain position to another position, and movement information of the limb or the finger of the wearer may be acquired using a method other than these.

### <Processing of Displaying Hand of Wearer on Virtual Object When Wearer Is Moving>

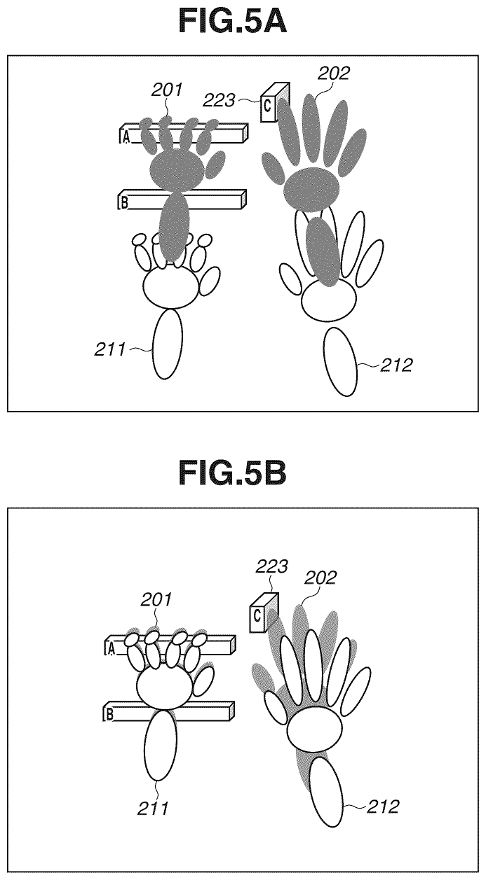

FIG. 5A is a diagram illustrating an example of displaying a virtual object being superimposed on a hand of a wearer. In this example, the virtual objects 231 and 232 are displayed being superimposed on the left hand 211 and the right hand 212, respectively.

FIG. 5B is a diagram illustrating an example of displaying a virtual object in such a manner that a hand of a wearer on the virtual object is displayed. In this example, the left hand 211 and the right hand 212 displayed on the virtual objects 231 and 232, respectively.

Normally, a virtual object is displayed being superimposed on a hand of a wearer as illustrated in FIG. 5A, but when a wearer is moving, the display may be changed. For example, when the virtual object 232 is pressing in the member C (223) and the wearer moves the right hand 212 of himself/herself to the same position, a virtual object is displayed in such a manner that a hand of a wearer on the virtual object is displayed as illustrated in FIG. 5B. In other words, the hand of the wearer is displayed on the foreside of the virtual object. With this configuration, when the wearer tries to match the position of his/her hand with the position of the virtual object, because the wearer has a good view of his/her hand, the wearer can move his/her hand more easily.

In this case, in the flowchart illustrated in FIG. 4, in step S403, the control unit 123 changes the display of a virtual object as if the virtual object was arranged beneath the hand of the wearer.

Alternatively, a virtual object may be always displayed at a similar transparency without changing the display of the virtual object, or a virtual object may be displayed in such a manner that a positional relationship between the body of the user and the virtual object always becomes the same. Here, the transparency is an index indicating that the transparency becomes higher as a virtual object becomes more transparent (i.e., as an object located behind and viewed through the virtual object becomes more visually recognizable), and the transparency becomes lower as the virtual object becomes less transparent (i.e., as an object located behind and viewed through the virtual object becomes less visually recognizable).

### <Reproduction Control: Start Reproduction If Region Comes to Start Position>

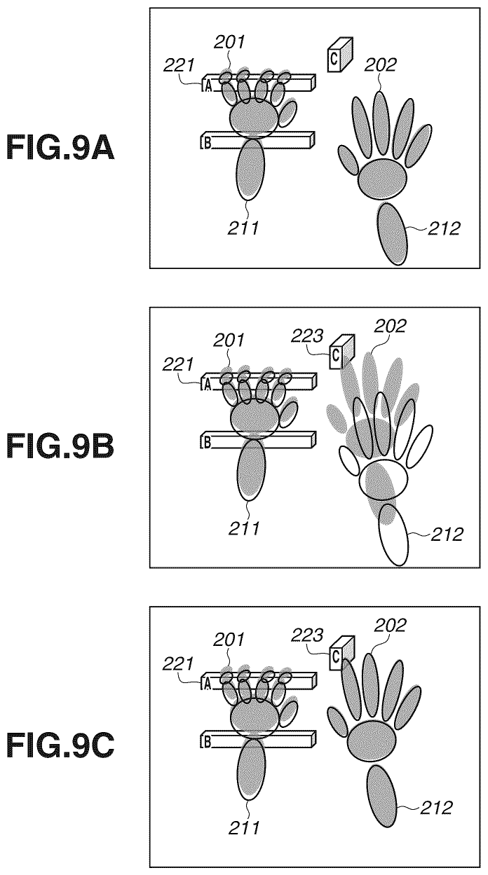

FIG. 9A is a diagram illustrating an example of starting moving image reproduction of a virtual object.

FIG. 9A illustrates a scene in which the virtual object 231 indicating the left hand grasps the member A (221), the virtual object 232 indicating the right hand falls within the viewing field of the display apparatus 101, and the wearer matches the positions of the left hand 211 and the right hand 212 to the same positions as the positions of the virtual objects. As illustrated in FIG. 9A, when the same region of the body of the wearer as a region of the body of a virtual object corresponding to an instructor is placed at the same position as the position of the virtual object, the reproduction of a moving image starts.

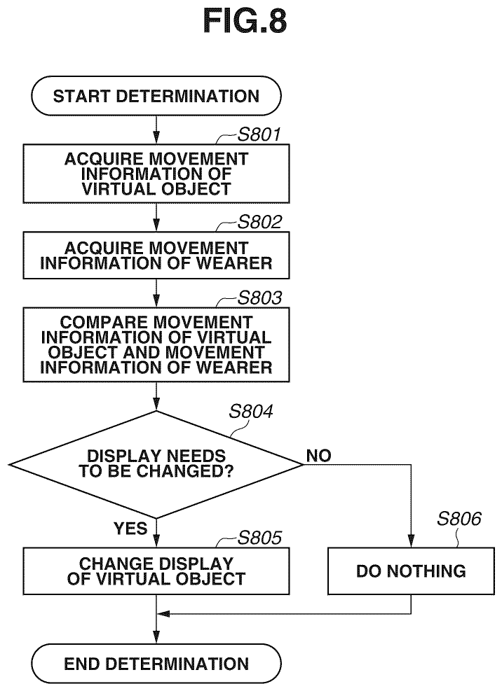

If the description is given in accordance with a flowchart illustrating processing of comparing movement information of a virtual object and movement information of a wearer in FIG. 8, in step S804, the control unit 123 determines whether the hand of the wearer has come to the same position as the position of the virtual object. In step S804, in a case where the control unit 123 determines that the hand of the wearer exists at the same position as the position of the virtual object (YES in step S804), the processing proceeds to step S805, and in a case where the control unit 123 determines that the hand of the wearer does not exist at the same position as the position of the virtual object (NO in step S804), the processing proceeds to step S806. At this time, the control unit 123 checks positions of the member A (221), the member B (222), and the member C (223), which are real objects, and displays the virtual objects 231 and 232 at positions where the virtual objects 231 and 232 appear to operate these members. The control unit 123 checks whether a difference between the position of the virtual object and the position of the wearer is smaller than a fixed threshold value and a movement amount of the wearer per second is smaller than a threshold value, and if a time during which these values are smaller than the threshold values continues for a certain period of time, the control unit 123 determines that the hand of the wearer has come to the same position as the position of the virtual object. In this step, the control unit 123 confirms that the hand of the wearer is at rest at a correct position, not passing through the same position as the position of the virtual object.

In step S805, the control unit 123 controls the reproduction of a video of the virtual object to start.

In step S806, the control unit 123 completes the processing without doing anything (i.e., by controlling reproduction not to start).

In this case, by arranging a region of the body of the wearer at the position of the virtual object, it becomes possible to start the reproduction of a video of the virtual object.

The reproduction of a moving image may be started by displaying all regions of the body of an instructor appearing within a viewing field of the display apparatus 101, and arranging only required regions among these regions at the same position as the position of a predetermined region of a learner, which is a wearer (i.e., matching the required regions with the position of the predetermined region), as virtual objects. When the reproduction of a moving image starts, regions of the body that appear as virtual objects, and regions of the body of the wearer may entirely match or may partially match. In the case of starting reproduction if only a part of displayed virtual objects match, among the displayed virtual objects, the display of virtual objects to be matched with the position of the predetermined region may be changed by intensified display or the like. For example, in a case where the virtual objects are surrounded by colored frames, it becomes possible for the learner, which is a wearer, to recognize an important region to be matched.

### <Reproduction Control: Reproduction Stop>

FIG. 9B is a diagram illustrating an example of stopping moving image reproduction of a virtual object. When a video of a virtual object is reproduced, an end of a series of movements is regarded as a breakpoint, and the reproduction may be paused at the timing at which the video is reproduced up to the breakpoint. FIG. 9B illustrates a scene in which the virtual object 231 and the left hand grasp the member A (221), and the virtual object 232 moves the hand toward the member C (223) in order to press in the member C (223), and the wearer is moving his/her hand in such a manner as to match the right hand of the virtual object 232. At this time, the virtual object 232 pressing in the member C (223) and stopping the movement correspond to a series of movements, and if the series of movements ends, the reproduction of the video of the virtual object is paused. The reproduction may be paused upon the lapse of a predetermined time.

When generating, from movement information and human body shape information of limbs and fingers of an instructor that are stored in the ROM 130, limbs and fingers of the instructor as a CG serving as a virtual object, the control unit 123 may generate information regarding these series of movements, and add the information to movement information of the virtual object.

The sections 301 and 302 in FIG. 3A each indicate a series of movements of the virtual object. A breakpoint is provided between the sections 301 and 302, and when the control unit 123 reproduces a moving image of the generated virtual object in accordance with the movement information, if a series of movements surrounded by the section 301 is reproduced, the reproduction of the video of the virtual object is paused.

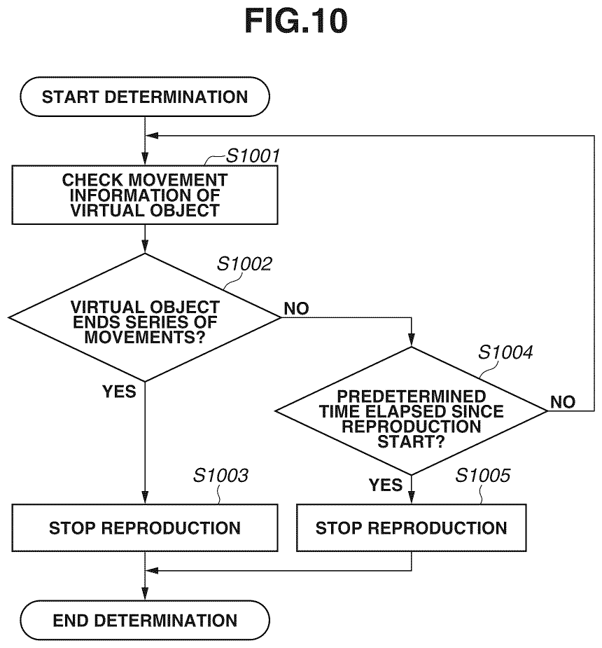

A flowchart in which processing of stopping the reproduction of a video of a virtual object corresponding to an instructor is performed will be described with reference to FIG. 10.

In step S1001, the control unit 123 acquires movement information of a virtual object from the ROM 130, and the processing proceeds to step S1002.

In step S1002, the control unit 123 determines whether the virtual object has ended a series of movements, based on the acquired movement information. In a case where the control unit 123 determines that the series of movements has ended (YES in step S1002), the processing proceeds to step S1003. In a case where the control unit 123 determines that the series of movements has not ended (NO in step S1002), the processing proceeds to step S1004.

In step S1003, at the time point at which the series of movements ends, the control unit 123 stops the reproduction of the video of the virtual object and completes the processing.

In step S1004, the control unit 123 determines whether a predetermined time has elapsed since the reproduction of the video of the virtual object has started. In a case where the control unit 123 determines that the predetermined time has elapsed since the reproduction of the video of the virtual object has started (YES in step S1004), the processing proceeds to step S1005.

In a case where the control unit 123 determines that the predetermined time has elapsed since the reproduction of the video of the virtual object has started (NO in step S1004), the processing proceeds to step S1001.

In step S1005, the control unit 123 stops the reproduction of the video of the virtual object and completes the processing.

In this manner, the wearer becomes able to stop moving image reproduction after the virtual object has performed a series of operations, without manually performing an operation. In a case where a series of operations are long, if a predetermined time elapses, it becomes possible to stop moving image reproduction even in mid-course of the series of operations.

### <Reproduction Control: Processing of Restarting Reproduction of Video>

FIG. 9C is a diagram illustrating an example of restarting moving image reproduction of a virtual object. In this example, FIG. 9C illustrates a scene in which the right hand 212 of the wearer is pressing in the member C (223) similarly to the virtual object 232 indicating the right hand in FIG. 9B.

If the description is given in accordance with the flowchart illustrating the processing of comparing movement information of a virtual object and movement information of a wearer in FIG. 8, in step S804, the control unit 123 determines whether a predetermined region of the body of the wearer has made the same movement as the virtual object. At this time, the wearer views a series of movements of the virtual object in the section surrounded by the section 301 in FIG. 3A, as a moving image, and tries to perform the same movement as the series of movements. In a case where a difference in movement amount between the virtual object and the wearer is smaller than a predetermined threshold value, the control unit 123 determines that the predetermined region of the body of the wearer has made the same movement as the virtual object. In other words, in a case where a difference in movement amount between the virtual object and the wearer is smaller than the predetermined threshold value, the control unit 123 determines in step S804 that the virtual object and the wearer have made the same movement (YES in step S804), and the processing proceeds to step S805. In a case where a difference in movement amount between the virtual object and the wearer is equal to or greater than the predetermined threshold value, the control unit 123 determines that the virtual object and the wearer have made different movements (NO in step S804), and the processing proceeds to step S806.

In step S805, the control unit 123 restarts the reproduction of the video of the virtual object. In a case where a video in the section 301 has been reproduced, in step S805, the control unit 123 reproduces a video in the section 302.

In step S806, the control unit 123 completes the processing without doing anything (i.e., by controlling the reproduction of the video of the virtual object not to be restarted).

In a case where the processing proceeds to step S806, because the reproduction of the video of the virtual object is not started, in order to start the reproduction of the video of the virtual object, the wearer may be prompted to reproduce a series of movements again, by notifying the wearer that the virtual object and the wearer have made different movements.

As described above, the next series of movements may be reproduced if the wearer arranges the predetermined region of the body at the same position as the position of the virtual object and brings the predetermined region into a still state.

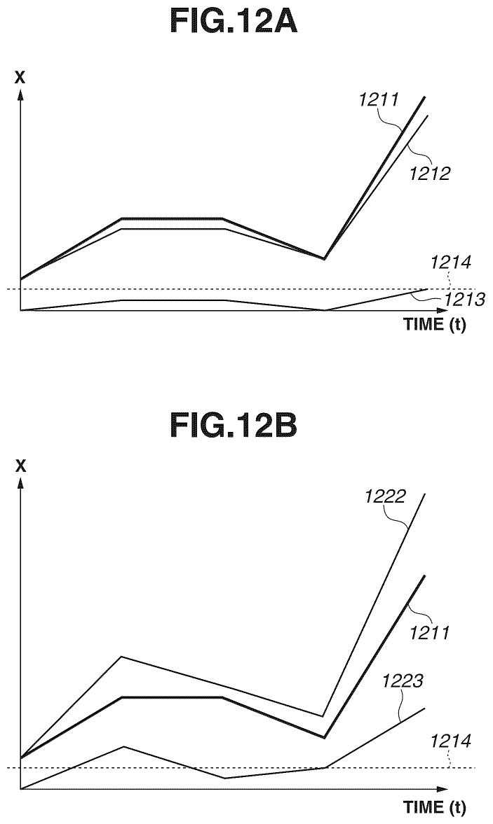

Here, the calculation of a difference in movement amount between the virtual object and the wearer, and a method of determining whether the virtual object and the wearer have made the same movement will be described with reference to FIGS. 12A and 12B. FIG. 12A illustrates a movement locus 1211 of an x-coordinate of a virtual object corresponding to an instructor, a movement locus 1212 of a learner, and a change 1213 in difference between the two movement loci. In addition, a dotted line 1214 indicates a threshold value.

FIG. 12A illustrates movement loci only for the x-coordinate. FIG. 12A illustrates a case where a difference between the movement locus of the virtual object and the movement locus of the learner is smaller than the threshold value.

FIG. 12B illustrates the movement locus 1211 of the virtual object corresponding to an instructor, a movement locus 1222 of a learner, and a change 1223 in difference between the two movement loci. In addition, the dotted line 1214 indicates a threshold value. FIG. 12B illustrates movement loci only for the x-coordinate. FIG. 12B illustrates a case where a difference between the movement locus of the virtual object and the movement locus of the learner becomes equal to or greater than the threshold value in some periods. In a case where a difference between the movement locus of the virtual object and the movement locus of the learner is smaller than the threshold value during the series of movements as illustrated in FIG. 12A, the control unit 123 determines that the virtual object and the wearer have made the same movement. In a case where a difference between the movement locus of the virtual object and the movement locus of the learner is equal to or greater than the threshold value in some periods during the series of movements as illustrated in FIG. 12B, the control unit 123 determines that the virtual object and the wearer are making different movements.

By integrating the difference only during the series of movements, calculating the total area, and then comparing with an area of a part where the difference is the threshold value, it may be determined whether the difference is smaller than the threshold value. Alternatively, it may be determined whether a difference in position between a virtual object and a wearer at each time in FIG. 3 is smaller than the threshold value.

With this configuration, by restarting moving image reproduction of the virtual object in a case where the wearer has performed the same operation as the virtual object, the wearer becomes able to view the next movement without manually performing an operation.

### <Reproduction Control: Processing of Reproducing Moving Image Retroactive to Timing at Which Virtual Object and Wearer Made Different Movements>

The start, the stop, and the restart of moving image reproduction have been described so far. In a case where the wearer cannot make the same movement as the virtual object, the moving image of the virtual object may be retroactively reproduced again.

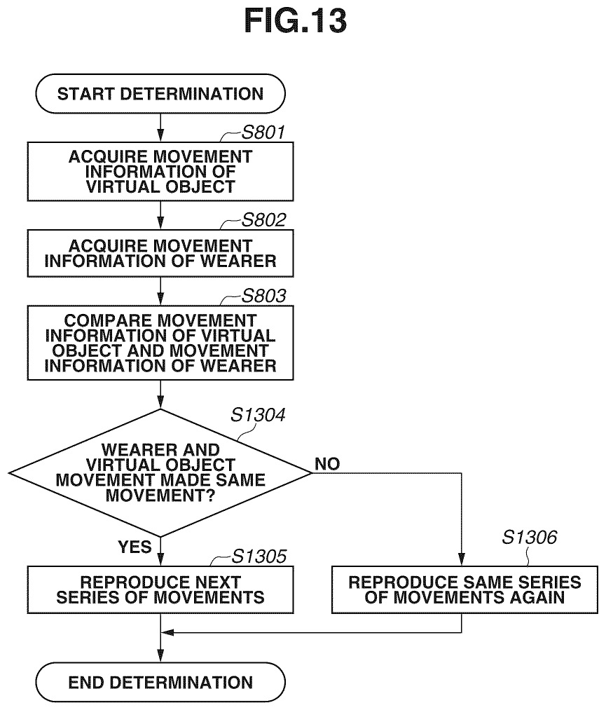

Processing of retroactively reproducing a series of movements again in a case where the wearer moves differently from the virtual object will be described with reference to FIG. 13.

The description of the processing in steps S801 to S803 will be omitted.

In step S1304, the control unit 123 determines whether a predetermined region of the body of the wearer has made the same movement as the virtual object. At this time, the wearer views a series of movements of the virtual object in the section surrounded by the section 301 in FIG. 3A, as a moving image, and tries to perform the same movement as the series of movements. In a case where a difference in movement amount between the virtual object and the wearer is smaller than a predetermined threshold value, the control unit 123 determines that the predetermined region of the body of the wearer has made the same movement as the virtual object. In other words, in a case where a difference in movement amount between the virtual object and the wearer is smaller than the predetermined threshold value, the control unit 123 determines in step S1304 that the virtual object and the wearer have made the same movement (YES in step S1304), and the processing proceeds to step S1305. In a case where a difference in movement amount between the virtual object and the wearer is equal to or greater than the predetermined threshold value, the control unit 123 determines that the virtual object and the wearer have made different movements (NO in step S1304), and the processing proceeds to step S1306.

In step S1305, the control unit 123 restarts the reproduction of the video of the virtual object. In a case where a video in the section 301 in FIG. 3A has been reproduced, in step S1305, the control unit 123 reproduces a video in the section 302 in FIG. 3A.

In step S1306, the control unit 123 reproduces the series of movements of the virtual object again. In other words, in a case where a video in the section 301 in FIG. 3A has been reproduced, in step S1306, the control unit 123 reproduces the video in the section 301 in FIG. 3A again.

With this configuration, by retroactively reproducing the moving image of the virtual object in a case where the wearer cannot make the same movement as the virtual object, the wearer becomes able to recheck the movement of the virtual object.

In the first exemplary embodiment, an example in the mixed reality has been described, but the example is not limited to this, the above-described processing may be executed on a virtual space. In the case of the virtual space, a virtual object corresponding to a wearer is displayed on the display unit 112. At least any of the position, the orientation, or the movement locus of the wearer may be acquired as described above, and comparison may be made by calculating a difference.

In the first exemplary embodiment, an example of a video see-through method of displaying a virtual object on the display unit 112 being superimposed on a captured image acquired by the imaging unit 111 has been described, but the example is not limited to this. An optical see-through method of displaying a virtual object corresponding to an instructor, on the display unit 112 in such a manner that a real space located behind is viewed through the virtual object on the display unit 112 may be employed.

### <Processing of Switching Display Method of Avatar>

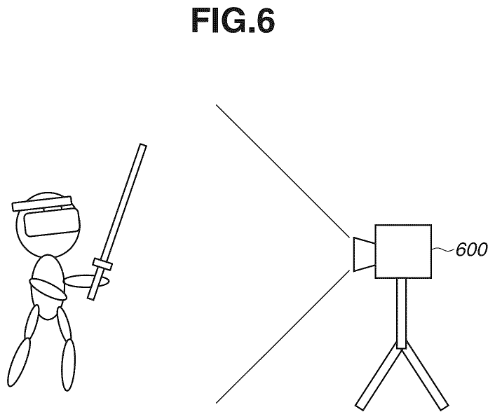

A second exemplary embodiment will be described. FIG. 6 is a schematic diagram illustrating a case of capturing an image of a wearer of the display apparatus 101 using an external camera. An external camera 600 captures a full-length image of the wearer of the display apparatus 101, and transmits the captured image to the HMD 100. The control unit 123 of the control apparatus 102 receives the image captured by the external camera 600, from the external camera 600 via the communication unit 180.

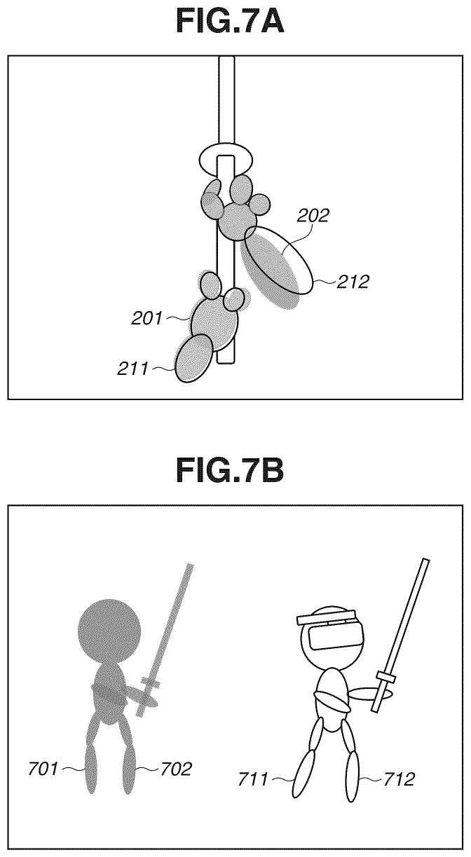

FIG. 7A illustrates an image to be displayed on the display unit 112, and a range displayed thereon is a range of a viewing field of the HMD 100. FIG. 7A is a diagram illustrating an example of an image to be displayed when a difference between a wearer and a virtual object exists within a viewing field of the wearer. In this example, the virtual objects 231 and 232, the left hand 211, and the right hand 212 can be displayed within the viewing field. The wearer can compare the position of the virtual object and the position of his/her hand, and match the position of his/her hand or arm with the position of the virtual object.

FIG. 7B is a diagram illustrating an example of an image to be displayed when a difference between a wearer and a virtual object exists outside a viewing field of the wearer. FIG. 7B illustrates an image to be displayed on the display unit 112. In this example, a full-length image of an instructor represented as a virtual object, and a full-length image of the wearer of the HMD 100 that has been captured using the external camera 600 are displayed. A virtual object 701 indicates a right leg of the instructor and a virtual object 702 indicates a left leg of the instructor, and a right leg 711 and aa left leg 712 are a right leg and a left leg of the wearer of the HMD 100 that have been image-captured using the external camera 600.

In this example, the virtual objects 701 and 702, the right leg 711, and the left leg 712 cannot be displayed within the viewing field. In this example, the virtual object 701 and the right leg 711 are different, and fall outside the viewing field. For this reason, a full-length image needs to be displayed on the display unit 112 as illustrated in FIG. 7B.

The control unit 123 acquires a full-length image of the wearer that has been captured using the external camera 600, via the communication unit 180, and displays the acquired full-length image of the wearer and the full-length image of the virtual object on the display unit 112 as a combined image. The full-length image of the wearer that has been captured using the external camera 600 may be displayed over the entire display unit 112, or may be displayed together with a video of the inside of the viewing field as illustrated in FIG. 7A, by displaying the full-length image on a part of the display unit 112. An image may be transmitted to an external display apparatus in such a manner that an image displayed on the display unit 112 is displayed also on the external display apparatus. Because only the learner can view the display apparatus 101, the image may be presented to an instructor giving an instruction to a learner at another location.

The control unit 123 controls a full-length image serving as a virtual object, to be reproduced in accordance with movement information stored in the ROM 130.

The flowchart illustrating the processing of comparing movement information of a virtual object and movement information of a wearer will be described with reference to FIG. 8.

In step S801, the control unit 123 acquires movement information of a virtual object from the ROM 130, and the processing proceeds to step S802.

In step S802, the control unit 123 acquires movement information of a wearer from the movement information acquisition unit 124, and the processing proceeds to step S803.

In step S803, the control unit 123 compares the movement information of the virtual object and the movement information of the wearer, and the processing proceeds to step S804.

In step S804, the control unit 123 determines whether the display needs to be changed, based on a comparison result obtained in step S803. In a case where the control unit 123 determines in step S804 that the display needs to be changed (YES in step S804), the processing proceeds to step S805. In a case where the control unit 123 determines that the display needs not be changed (NO in step S804), the processing proceeds to step S806. At this time, taking the cases of the examples in FIGS. 7A and 7B, a portion having a difference in movement information between the virtual object and the wearer corresponds to a hand portion in the case of the virtual object 231 and the left hand 211, or the virtual object 232 and the right hand 212, which falls within the viewing field of the display apparatus 101.

In a case where a portion having a difference in movement information between the virtual object and the wearer corresponds to the virtual object 701 and the right leg 711, or the virtual object 702 and the left leg 712, because the difference falls outside the viewing field of the display apparatus 101, it is determined that the display of the virtual object needs to be changed to display a full-length image of the virtual object.

In step S805, the control unit 123 changes the display of the virtual object, displays a full-length image of the virtual object, and completes the processing.

In step S806, the control unit 123 completes the processing without doing anything.

In this manner, when a portion where the movement of the wearer differs from the movement of the virtual object falls outside the range of the viewing field, by changing the display of the virtual object in such a manner as to display a full-length image, in the example illustrated in FIG. 7B, the wearer becomes able to notice that the movement of his/her right leg differs from the movement of the virtual object.

<Reproduction Control: Perform Reproduction Processing and Stop Processing of Period during Which Different Movements Are Made, for Second Time or Later>

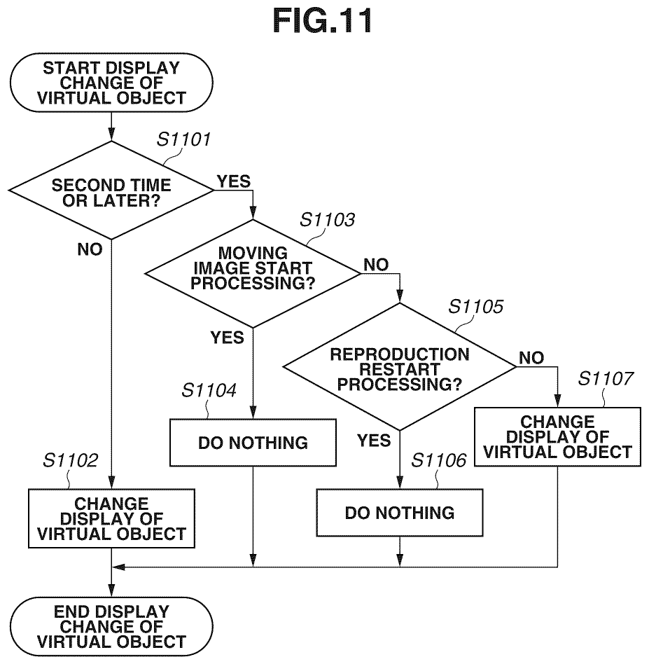

A third exemplary embodiment will be described. When learning is executed for the second time or later, because the wearer has already viewed the moving image of the virtual object, the wearer sometimes feels bothersome if the entire moving image is reproduced. In this case, in order to learn a period during which the wearer fails to correctly move, or a period during which the wearer wrongly moves, a video of the virtual object may be displayed and reproduced for only a period during which the wearer has made a movement different from that of the virtual object. In a case where the learning is executed for the second time or later, when the display of the virtual object is changed in step S805 of FIG. 8, only reproduction processing and reproduction stop processing of the period during which the wearer wrongly moves are performed. A flowchart illustrating processing of determining whether to display a video of a virtual object when learning is executed for the second time or later will be described with reference to FIG. 11.

In step S1101, the control unit 123 determines whether it is the second time or later the wearer views a moving image of a virtual object. In a case where the control unit 123 determines that the wearer views a moving image of a virtual object for the first time (i.e., in a case where the control unit 123 determines that it is not the second time or later the wearer views a moving image of a virtual object (NO in step S1101), the processing proceeds to step S1102. In a case where the control unit 123 determines that it is the second time or later the wearer views a moving image of a virtual object, the processing proceeds to step S1103.

In step S1102, the control unit 123 controls the video of the virtual object to be displayed.

In step S1103, the control unit 123 determines whether display change processing is start processing of moving image reproduction. In a case where the control unit 123 determines that the display change processing is start processing of moving image reproduction (YES in step S1103), the processing proceeds to step S1104. In a case where the control unit 123 determines that the display change processing is not start processing of moving image reproduction (NO in step S1103), the processing proceeds to step S1105.

In step S1104, the control unit 123 completes the processing without doing anything.

In step S1105, the control unit 123 determines whether the display change processing is restart processing of moving image reproduction. In a case where the control unit 123 determines that the display change processing is restart processing of moving image reproduction (YES in step S1105), the processing proceeds to step S1106. In a case where the control unit 123 determines that the display change processing is not restart processing of moving image reproduction (NO in step S1105), the processing proceeds to step S1107.

In step S1106, the control unit 123 completes the processing without doing anything.

In step S1107, the control unit 123 controls the video of the virtual object to be displayed.

By executing the processing in accordance with the flowchart in FIG. 11, when learning is executed for the second time or later, the processing of starting the reproduction of a moving image by placing a predetermined region of the learner at a start position and processing of stopping the reproduction of the video of the virtual object due to a difference in movement locus can be omitted. For example, when learning is executed for the second time or later, instead of starting the reproduction of a moving image by placing a predetermined region of the learner at a start position, the learner starts a series of movements in the section 301 without following the movement of the virtual object. If a movement locus matches a movement locus of a non-displayed virtual object in the series of movements in the section 301, the next series of movements in the section 302 are performed without stopping the series of movements in the section 301, with a virtual object being not displayed. If a movement locus of a learner and a movement locus of a virtual object corresponding to an instructor match, the movements in the sections 301 and 302 can be ended with a virtual object being not displayed. If a movement locus of a learner and a movement locus of a virtual object corresponding to an instructor do not match, a virtual object is displayed. In a case where a movement locus of a learner and a movement locus of a virtual object corresponding to an instructor do not match and a virtual object is displayed, the virtual object may be brought into a non-display state again at a timing at which the series of movements ends. In a case where a movement locus of a learner and a movement locus of a virtual object corresponding to an instructor do not match and a virtual object is displayed, the virtual object may be brought into a non-display state again at a timing at which the movement locus of the learner and the movement locus of the virtual object corresponding to the instructor match.

According to an exemplary embodiment of the present disclosure, it is possible to reduce a failure in recognition of a working operation of the learner that is caused depending on the position and the orientation of a region of the body of the learner.

### Other Exemplary Embodiments

The present disclosure is also implemented by executing the following processing. More specifically, the processing is processing of supplying software (program) implementing the function of the above-described exemplary embodiment, to a system or an apparatus via a network or various storage media, and a computer (or control unit, micro processing unit (MPU), etc.) of the system or the apparatus reading out and executing the program code. In this case, a storage medium storing the program and the program constitute the present disclosure.

Heretofore, exemplary embodiments of the present disclosure have been described in detail, but the present disclosure is not limited to these specific exemplary embodiments, and various configurations are also included in the present disclosure without departing from the gist of the disclosure. The above-described exemplary embodiments may be partially combined as appropriate.

Each functional unit in each of the above-described exemplary embodiments (each modified example) can be an individual hardware component or not an individual hardware component. Functions of two or more functional units may be implemented by common hardware. Each of a plurality of functions of one functional unit may be implemented by an individual hardware component. Two or more functions of one functional unit may be implemented by common hardware. Each functional unit may be implemented by hardware such as an application specific integrated circuit (ASIC), a Field Programmable Gate Array (FPGA), or a digital signal processor (DSP), or needs not be implemented by hardware. For example, an apparatus may include a processor and a memory (storage medium) storing a control program. Then, functions of at least a part of functional units included in the apparatus may be implemented by the processor reading out the control program from the memory and executing the control program.

The present disclosure can also be implemented by processing of supplying a program implementing one or more functions of the above-described exemplary embodiment, to a system or an apparatus via a network or a storage medium, and one or more processors in a computer of the system or the apparatus reading out and executing the program. The present disclosure can also be implemented by a circuit implementing the one or more functions (for example, ASIC).

### Configuration 1

An information processing apparatus including:
a first acquisition unit configured to acquire first information regarding a position or an orientation of a virtual object corresponding to an instructor, from a recording unit;
a second acquisition unit configured to acquire second information regarding a position or an orientation of an operation apparatus supported by a learner; and
a control unit configured to control reproduction of a video of the virtual object corresponding to the instructor, based on a difference between the first information acquired by the first acquisition unit and the second information acquired by the second acquisition unit.

### Configuration 2

The information processing apparatus according to Configuration 1, in which the control unit controls reproduction of the video of the virtual object corresponding to the instructor, to be started in a case where the difference is smaller than a predetermined threshold value.

### Configuration 3

The information processing apparatus according to Configuration 2, in which the control unit controls reproduction of the video of the virtual object corresponding to the instructor, to be started in a case where a difference between the first information acquired by the first acquisition unit at a predetermined time point and the second information acquired by the second acquisition unit is smaller than the predetermined threshold value.

### Configuration 4

The information processing apparatus according to Configuration 2 or 3, in which the control unit controls reproduction of the video of the virtual object corresponding to the instructor, to be started in a case where a difference between a movement locus that is based on the first information in a predetermined period and a movement locus that is based on the second information in a predetermined period is smaller than the predetermined threshold value.

### Configuration 5

The information processing apparatus according to Configuration 4,
in which the control unit controls the video of the virtual object corresponding to the instructor, to be reproduced from a first time point to a second time point, and controls the video to be paused at the second time point, and
in which the control unit starts reproduction of the video of the virtual object corresponding to the instructor, from the second time point in a case where a difference between a movement locus that is based on the first information from the first time point to the second time point and a movement locus that is based on the second information from the first time point to the second time point is smaller than the predetermined threshold value.

### Configuration 6

The information processing apparatus according to Configuration 4,
in which the control unit controls the video of the virtual object corresponding to the instructor, to be reproduced from a first time point to a second time point, and controls the video to be paused at the second time point, and
in which the control unit starts reproduction of the video of the virtual object corresponding to the instructor, from the first time point in a case where a difference between a movement locus that is based on the first information from the first time point to the second time point and a movement locus that is based on the second information from the first time point to the second time point is equal to or greater than the predetermined threshold value.

### Configuration 7

The information processing apparatus according to Configuration 4, in which, in a case where a difference between a movement locus that is based on the first information and a movement locus that is based on the second information is equal to or greater than the predetermined threshold value in some periods from a first time point to a second time point, the control unit stops reproduction of the video of the virtual object corresponding to the instructor at the second time point.

### Configuration 8

The information processing apparatus according to any one of Configurations 1 to 7, further including a notification unit configured to, in a case where the difference is equal to or greater than a predetermined threshold value, notify that the difference is equal to or greater than the predetermined threshold value.

### Configuration 9

The information processing apparatus according to Configuration 8, in which the notification unit notifies that the difference is equal to or greater than the threshold value, on a display unit that displays the virtual object corresponding to the instructor.

### Configuration 10

The information processing apparatus according to any one of Configurations 1 to 9, in which the control unit controls a display method of the virtual object corresponding to the instructor to be changed depending on whether the difference is smaller than a predetermined threshold value.

### Configuration 11

The information processing apparatus according to Configuration 10, in which, in a case where the difference is smaller than the predetermined threshold value, the control unit controls transparency of the virtual object corresponding to the instructor to be higher than that in a case where the difference is equal to or greater than the predetermined threshold value.

### Configuration 12

The information processing apparatus according to Configuration 10, in which, in a case where the difference is smaller than the predetermined threshold value, the control unit controls the virtual object corresponding to the instructor to be displayed behind the learner, and in a case where the difference is equal to or greater than the predetermined threshold value, controls the virtual object corresponding to the instructor to be displayed on a foreside of the learner.

### Configuration 13

The information processing apparatus according to according to any one of Configurations 1 to 12, further including a third acquisition unit configured to acquire a captured image from an imaging unit, in which the control unit displays the virtual object corresponding to the instructor, being superimposed on the captured image acquired by the third acquisition unit.

### Configuration 14

The information processing apparatus according to according to any one of Configurations 1 to 13, further including a transmission unit configured to transmit the video of the virtual object corresponding to the instructor, to an optical see-through method display apparatus including a display unit.

### Configuration 15

The information processing apparatus according to according to any one of Configurations 1 to 14, in which the control unit controls the virtual object corresponding to the learner, to be displayed on a virtual space based on the second information.

### Configuration 16

The information processing apparatus according to according to any one of Configurations 1 to 15, further including a fourth acquisition unit configured to acquire the first information based on a position or an orientation of an operation apparatus supported by the instructor.

### Configuration 17

The information processing apparatus according to according to any one of Configurations 1 to 16, in which, in a case where reproduction of the video of the virtual object corresponding to the instructor is executed for a second time or later, the control unit controls the video of the virtual object corresponding to the instructor to be displayed during a period during which the difference is equal to or greater than a predetermined threshold value when the video of the virtual object corresponding to the instructor is reproduced for a first time, and the video of the virtual object corresponding to the instructor not to be displayed during a period during which the difference is smaller than the predetermined threshold value.

### Control Method

A control method of an information processing apparatus, including:
acquiring first information regarding a position or an orientation of a virtual object corresponding to an instructor, from a recording unit;
acquiring second information regarding a position or an orientation of an operation apparatus supported by a learner; and
controlling reproduction of a video of the virtual object corresponding to the instructor, based on a difference between the acquired first information and the acquired second information.

### Program

A program for causing a computer to function as each unit of the information processing apparatus according to Configuration 1.

### System

An information processing system including:
a first acquisition apparatus configured to acquire first information regarding a position or an orientation of a virtual object corresponding to an instructor, from a recording apparatus;
an operation apparatus to be supported by a learner;
a second acquisition apparatus configured to acquire second information regarding a position or an orientation of the operation apparatus; and
a control apparatus configured to control reproduction of a video of the virtual object corresponding to the instructor, based on a difference between the first information acquired by the first acquisition apparatus and the second information acquired by the second acquisition apparatus.

### OTHER EMBODIMENTS

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to exemplary embodiments, it is to be understood that the disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2023-191179, filed Nov. 8, 2023, which is hereby incorporated by reference herein in its entirety.

What is claimed is:

1. An information processing apparatus connected to or integrated into a head-mounted display apparatus comprising:
a processor; and
a memory storing a program which, when executed by the processor, causes the information processing apparatus to:
execute first acquisition processing of acquiring first information regarding a position or an orientation of a virtual object corresponding to an instructor from a recording unit;
execute second acquisition processing of acquiring second information regarding a position or an orientation of an operation apparatus supported by a learner; and
execute control processing of controlling reproduction of a video of the virtual object corresponding to the instructor, based on a difference between the first information acquired by the first acquisition processing and the second information acquired by the second acquisition processing.

2. The information processing apparatus according to claim 1, wherein the control processing controls reproduction of the video of the virtual object corresponding to the instructor, to be started in a case where the difference is smaller than a predetermined threshold value.

3. The information processing apparatus according to claim 2, wherein the control processing controls reproduction of the video of the virtual object corresponding to the instructor, to be started in a case where a difference between the first information acquired by the first acquisition processing at a predetermined time point and the second information acquired by the second acquisition processing is smaller than the predetermined threshold value.

4. The information processing apparatus according to claim 2, wherein the control processing controls reproduction of the video of the virtual object corresponding to the instructor, to be started in a case where a difference between a movement locus that is based on the first information in a predetermined period and a movement locus that is based on the second information in a predetermined period is smaller than the predetermined threshold value.

5. The information processing apparatus according to claim 4,
wherein the control processing controls the video of the virtual object corresponding to the instructor to be reproduced from a first time point to a second time point, and controls the video to be paused at the second time point, and
wherein the control processing starts reproduction of the video of the virtual object corresponding to the instructor, from the second time point in a case where a difference between a movement locus that is based on the first information from the first time point to the second time point and a movement locus that is based on the second information from the first time point to the second time point is smaller than the predetermined threshold value.

6. The information processing apparatus according to claim 4,
wherein the control processing controls the video of the virtual object corresponding to the instructor to be reproduced from a first time point to a second time point, and controls the video to be paused at the second time point, and
wherein the control processing starts reproduction of the video of the virtual object corresponding to the instructor, from the first time point in a case where a difference between a movement locus that is based on the first information from the first time point to the second time point, and a movement locus that is based on the second information from the first time point to the second time point is equal to or greater than the predetermined threshold value.

7. The information processing apparatus according to claim 4, wherein, in a case where a difference between a movement locus that is based on the first information and a movement locus that is based on the second information is equal to or greater than the predetermined threshold value in some periods from a first time point to a second time point, the control processing stops reproduction of the video of the virtual object corresponding to the instructor at the second time point.

8. The information processing apparatus according to claim 1, wherein the program, when executed by the processor, further causes the information processing apparatus to execute, in a case where the difference between the first information acquired by the first acquisition processing and the second information acquired by the second acquisition processing is equal to or greater than a predetermined threshold value, notification processing of notifying that the difference is equal to or greater than the predetermined threshold value.

9. The information processing apparatus according to claim 8, wherein the notification processing notifies that the difference is equal to or greater than the threshold value, on a display that displays the virtual object corresponding to the instructor.

10. The information processing apparatus according to claim 1, wherein the control processing controls a display method of the virtual object corresponding to the instructor, to be changed depending on whether the difference is smaller than a predetermined threshold value.

11. The information processing apparatus according to claim 10, wherein, in a case where the difference is smaller than the predetermined threshold value, the control processing controls transparency of the virtual object corresponding to the instructor to be higher than that in a case where the difference is equal to or greater than the predetermined threshold value.

12. The information processing apparatus according to claim 10, wherein, in a case where the difference is smaller than the predetermined threshold value, the control processing controls the virtual object corresponding to the instructor to be displayed behind the learner, and in a case where the difference is equal to or greater than the predetermined threshold value, controls the virtual object corresponding to the instructor to be displayed on a foreside of the learner.

13. The information processing apparatus according to claim 1,
wherein the program, when executed by the processor, further causes the information processing apparatus to execute third acquisition processing of acquiring a captured image from an imaging unit, and
wherein the control processing displays the virtual object corresponding to the instructor, being superimposed on the captured image acquired by the third acquisition processing.

14. The information processing apparatus according to claim 1, wherein the program, when executed by the processor, further causes the information processing apparatus to execute transmission processing of transmitting the video of the virtual object corresponding to the instructor, to an optical see-through method display apparatus including a display unit.

15. The information processing apparatus according to claim 1, wherein the control processing controls the virtual object corresponding to the learner to be displayed on a virtual space based on the second information.

16. The information processing apparatus according to claim 1, wherein the program, when executed by the processor, further causes the information processing apparatus to execute fourth acquisition processing of acquiring the first information based on a position or an orientation of an operation apparatus supported by the instructor.

17. The information processing apparatus according to claim 1, wherein, in a case where reproduction of the video of the virtual object corresponding to the instructor is executed for a second time or later, the control processing controls the video of the virtual object corresponding to the instructor to be displayed during a period during which the difference is equal to or greater than a predetermined threshold value when a video of the virtual object corresponding to the instructor is reproduced for a first time, and the video of the virtual object corresponding to the instructor not to be displayed during a period during which the difference is smaller than the predetermined threshold value.

18. A control method of an information processing apparatus, the control method comprising:
acquiring first information regarding a position or an orientation of a virtual object corresponding to an instructor, from a recording unit;
acquiring second information regarding a position or an orientation of an operation apparatus supported by a learner; and
controlling reproduction of a video of the virtual object corresponding to the instructor based on a difference between the acquired first information and the acquired second information.

19. A non-transitory computer readable storage medium that stores a program, wherein the program causes a computer to execute a control method, the method comprising:
acquiring first information regarding a position or an orientation of a virtual object corresponding to an instructor, from a recording unit;
acquiring second information regarding a position or an orientation of an operation apparatus supported by a learner; and
controlling reproduction of a video of the virtual object corresponding to the instructor, based on a difference between the acquired first information and the acquired second information.
